(19) United States
(12) Patent Application Publication
(10) Pub. No.: US 2014/0307352 A1
(43) Pub. Date: Oct. 16, 2014

(54) OVERVOLTAGE PROTECTION CIRCUIT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/059,311

(22) Filed: Oct. 21, 2013

(30) Foreign Application Priority Data
Apr. 16, 2013 (CN) 2013101305591

(51) Int. Cl. H02H 3/20

(52) U.S. Cl. CPC H02H 3/20
USPC 361/18

(57) ABSTRACT

An overvoltage protection circuit includes a first connector connected to an alternating current (AC) power source, a second connector connected to an electronic device, an alternating current to direct current (AC/DC) rectifying circuit, a voltage regulating diode, a relay, a first electronic switch, and a second electronic switch. The first connector is connected to the AC/DC rectifying circuit. The AC/DC rectifying circuit is connected to the first electronic switch through the voltage regulating diode. The first electronic switch is connected to the second electronic switch. The second electronic switch is connected to the relay. The first connector is connected to the second connector through the relay.

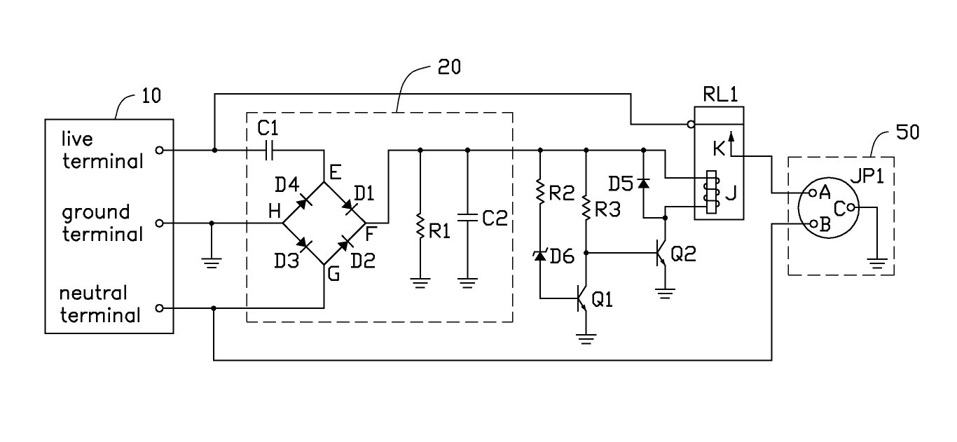

### BACKGROUND

1. Technical Field

The present disclosure relates to an overvoltage protection circuit.

2. Description of Related Art

Some electronic equipment is powered by an alternating current (AC) power source. The electronic equipment may be damaged by overvoltage from the AC power source, and more seriously, fire or electric shock may occur. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a circuit diagram of an embodiment of an overvoltage protection circuit.

### DETAILED DESCRIPTION

The disclosure, including the accompanying drawing, is illustrated by way of example and not by way of limitation. References to “an” or “one” embodiment in this disclosure are not necessarily to the same embodiment, and such references mean at least one.

The FIGURE is an embodiment of an overvoltage protection circuit. The overvoltage protection circuit includes a first connector 10 connected to an alternating current (AC) power source, a second connector 50 connected to electronic device, such as a computer, an alternating current to direct current (AC/DC) rectifying circuit 20, two resistors R2 and R3, a voltage regulating diode D6, a diode D5, a relay RL1, and two bipolar junction transistors (BJTs) Q1 and Q2. In the embodiment, the BJTs Q1 and Q2 are npn type BJTs. The second connector 50 is a three-hole power outlet JP1. The electronic device can be powered through a power plug connected to the power outlet JP1.

The AC/DC rectifying circuit 20 is connected to the first connector 10, and utilized to convert the AC power from the first connector 10 into DC power. The first connector 10 includes a ground terminal connected to the ground wire of the AC power source, a live terminal connected to the live wire of the AC power source, and a neutral terminal connected to the neutral wire of the AC power source. The ground terminal of the first connector 10 is grounded.

The AC/DC rectifying circuit 20 includes capacitors C1 and C2, diodes D1-D4 connected end to end, and a resistor R1. A node E between an anode of the diode D1 and a cathode of the diode D4 is connected to the live terminal of the first connector 10 through the capacitor C1. A node F between a cathode of the diode D1 and a cathode of the diode D2 is grounded through the resistor R1 and the capacitor C2 connected in parallel. A node G between an anode of the diode D2 and a cathode of the diode D3 is connected to the neutral terminal of the first connector 10. A node H between an anode of the diode D3 and an anode of the diode D4 is connected to the ground terminal of the first connector 10. The node F functions as an output terminal of the AC/DC rectifying circuit 20.

The node F is connected to a cathode of the voltage regulating diode D6 through the resistor R2. An anode of the voltage regulating diode D6 is connected to a base of the BJT Q1. A collector of the BJT Q1 is connected to the node F through the resistor R3. An emitter of the BJT Q1 is grounded.

The collector of the BJT Q1 is further connected to a base of the BJT Q2. A collector of the BJT Q2 is connected to an anode of the diode D5. A cathode of the diode D5 is connected to the node F. An emitter of the BJT Q2 is grounded.

The relay RL1 includes a coil J and a switch K. The switch K is turned on when there is current flowing through the coil J. The switch K is turned off when there is no current flowing through the coil J. A first terminal of the coil J is connected to the node F. A second terminal of the coil J is connected to the collector of the BJT Q2. A first terminal of the switch K is connected to the live terminal of the first connector 10. A second terminal of the switch K is connected to the second connector 50.

The second connector 50 includes a live pin A, a neutral pin B, and a ground pin C. The live pin A is connected to the second terminal of the switch K. The neutral pin B is connected to the neutral terminal of the first connector 10. The ground pin C is grounded.

The AC/DC rectifying circuit 20 converts the AC power received by the first connector 10 to the DC power. The AC/DC rectifying circuit 20 outputs the DC power through the node F. In the embodiment, a breakdown voltage U of the voltage regulating diode D6 is a preset voltage. When the voltage of node F is less than the preset voltage, the AC power source provides power to the electronic device. When the voltage of the node F is greater than or equal to the preset voltage, the electronic device is powered off.

In detail, when the voltage of the node F is less than the preset voltage, the voltage regulating diode D6 is turned off. The base of the BJT Q1 receives no signal and is turned off. The base of the BJT Q2 receives a high level signal, such as logic 1, and is turned on. There is current flowing through the coil J, and the switch K is turned on, such that the AC power source provides power to the electronic device.

When the voltage of the node F is greater than or equal to the preset voltage, the voltage regulating diode D6 is turned on. The base of the BJT Q1 receives a high level signal and is turned on. The base of the BJT Q2 receives a low level signal, such as logic 0, and is turned off. There is no current flowing through the coil J, and the switch K is turned off, such that the electronic device is powered off for overvoltage protection.

The diodes D1-D4 forms a rectification circuit, where the nodes E and G function as two inputs of the AC/DC rectifying circuit 20.

In other embodiments, the BJTs Q1 and Q2 can be replaced by other electronic switches, such as metallic oxide semiconductor field effect transistors.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An overvoltage protection circuit connected between an alternating current (AC) power source and an electronic device, the overvoltage protection circuit comprising:
a first resistor;
a voltage regulating diode;
a first connector connected to the AC power source, and comprising a positive terminal, a ground terminal, and a negative terminal;
a second connector connected to the electronic device, and comprising a positive pin, a negative pin, and a grounded ground pin;
an alternating current to direct current (AC/DC) rectifying circuit comprising first and second inputs, and an output, wherein the first input is connected to the positive terminal of the first connector, the second input is connected to the negative terminal of the first connector and connected to the negative pin of the second connector, and the output is connected to a cathode of the voltage regulating diode;
a first electronic switch comprising a control terminal connected to an anode of the voltage regulating diode, a first terminal connected to the output of the AC/DC rectifying circuit through the first resistor, and a second terminal grounded; wherein the first terminal of the first electronic switch is connected to the second terminal of the first electronic switch, in response to the control terminal of the first electronic switch receiving a high level signal; the first terminal of the first electronic switch is disconnected from the second terminal of the first electronic switch, in response to the control terminal of the first electronic switch receiving a low level signal;
a relay comprising a coil and a switch, wherein a first terminal of the coil is connected to the output of the AC/DC rectifying circuit, a first terminal of the switch is connected to the positive terminal of the first connector, the second terminal of the switch is connected to the positive pin of the second connector, and
a second electronic switch comprising a control terminal connected to the first terminal of the first electronic switch, a first terminal connected to a second terminal of the coil, and a second terminal grounded; wherein the first terminal of the second electronic switch is connected to the second terminal of the second electronic switch, in response to the control terminal of the second electronic switch receiving a high level signal; the first terminal of the second electronic switch is disconnected from the second terminal of the second electronic switch, in response to the control terminal of the second electronic switch receiving a low level signal.

2. The overvoltage protection circuit of claim 1, wherein the AC/DC rectifying circuit comprises first and second capacitors, first to fourth diodes connected end to end, and a second resistor, a node between an anode of the first diode and a cathode of the fourth diode functions as the first input of the AC/DC rectifying circuit, a node between a cathode of the first diode and a cathode of the second diode functions as the output of the AC/DC rectifying circuit, a node between an anode of the second diode and a cathode of the third diode functions as the second input of the AC/DC rectifying circuit, a node between an anode of the third diode and an anode of the fourth diode is grounded, the first input of the AC/DC rectifying circuit is connected to the positive terminal of the first connector through the first capacitor, the output of the AC/DC rectifying circuit is grounded through the second resistor and the second capacitor connected in parallel.

3. The overvoltage protection circuit of claim 2, further comprising a third resistor, wherein the cathode of the voltage regulating diode is connected to the output of the AC/DC rectifying circuit through the third resistor.

4. The overvoltage protection circuit of claim 3, further comprising a fifth diode, wherein the first terminal of the second electronic switch is connected to an anode of the fifth diode, a cathode of the fifth diode is connected to the output of the AC/DC rectifying circuit.

5. The overvoltage protection circuit of claim 1, wherein the first and second electronic switches are npn type bipolar junction transistors (BJTs), bases of the BJTs correspond to the control terminals of the first and second electronic switches, collectors of the BJTs correspond to the first terminals of the first and second electronic switches, and emitters of the BJTs correspond to the second terminals of the first and second electronic switches.
